(19) United States
(12) Patent Application Publication
(10) Pub. No.: US 2011/0271831 A1
(43) Pub. Date: Nov. 10, 2011

(54) WATER DEFLECTOR FOR A MUD PUMP

(76) Inventor: Occie Leon Gee, JR., Chico, TX (US)

(21) Appl. No.: 13/102,223

(22) Filed: May 6, 2011

Related U.S. Application Data
(60) Provisional application No. 61/332,074, filed on May 6, 2010.

(51) Int. Cl. F01P 11/04; B23P 11/00

(52) U.S. Cl. 92/145; 29/428

(57) ABSTRACT

A deflector preventing contamination of an oil sump by water is provided, comprising a collar frictionally locking about a cylinder liner end of the mud pump, a manifold having a tube directing water against a piston and connecting rod contained within the cylinder liner, and a shield extending across an upper portion of the cylinder liner end. The deflector may be attached to cylinder liners with or without modification. A method is provided for deflecting water being forcibly expelled from a horizontal cylinder by a piston stroke, comprising steps of positioning a shield across an upper portion of the cylinder liner end, arranging a tube to spray water against the piston, forcibly spraying water against the piston, allowing the water expelled from the cylinder liner to flow into a water reservoir under the influence of gravity, and deflecting the water into the water reservoir as it is forcibly expelled.

### CROSS-REFERENCES TO RELATED APPLICATIONS

This application claims the benefit of U.S. Provisional Patent Application Ser. No. 61/332,074, filed on May 6, 2010, the contents of which are hereby incorporated by reference in their entirety.

### BACKGROUND OF THE INVENTION

The present invention generally relates to methods and devices for use with piston pumps used in the oil industry for pumping mud into boreholes, and more particularly to systems, methods, and devices for deflecting water used in cooling pistons incorporated in said piston pumps, in order to avoid contamination of lubricating oil.

There are three basic types of fluid pumps used in oil and gas exploration drilling rigs and in water well drilling equipment. In the oil and gas drilling rigs, one of these basic types is referred to as a “mud pump”, which can be further broken down into two types: (a) a duplex pump which has two reciprocating pistons which force fluid into the discharge line and (b) a triplex reciprocating pump in which three pistons act to force fluid into the discharge line. The generic term “multiplex pumps” is occasionally used to include triplex pumps and those having up to six cylinders. These fluid pumps can be single acting, in which fluid is discharged on alternate strokes or double acting in which each stroke discharges fluid. An example of such a mud pump 100 of the prior art may be shown in FIG. 1.

The fluid pumps involved in this invention are of the horizontal reciprocating type in which one end is designated as the fluid end, which is involved in the actual movement of fluid, and the other end is designated as the power end, or gear end, which supplies the motivation for fluid movement. The fluid end includes a pump housing in which are fitted a number of cylinders corresponding to the number of pistons which are operated within the pump. The power end of the mud pump contains a power source and connecting rods designed for supplying reciprocal driving force. The power end may also have an oil pump 143 that is located in an open oil sump 145 containing lubricating oil for the crank shaft 140, or main jack shaft, that reciprocates the connecting rods 135. This open oil sump 145 may be positioned directly below the jack shaft 140 so that the shaft periodically dips the journals associated with the connecting rods into the oil sump 145 to bathe the joints with lubricating oil.

Each pump cylinder contains a piston which reciprocates through the pump cylinder by action of the connecting rod 135. The outermost portion of the each pump cylinder may be termed the cylinder liner 110 according to common usage in the oil industry. Other pump parts associated with the mud pump 100 are valve pots, seats, connecting rod seals 141, gaskets, and piston rubbers. The cylinder liner 110 and some of these parts are referred to as expendable elements.

The cylinder liner 110 may be subject to high wear rates due to a number of factors, such as the nature of the geological formation being drilled, the solids content in the fluid, the abrasive properties of these solids, and pH of the fluid, the pump pressure, strokes per minute of the piston 130, and the materials used in the various pump parts. Generally the cylinder liner 110 and piston 130 are subjected to high pressures and resultant high temperatures. These parts may be water cooled by spraying a water spray from a nozzle 133 directed against the power end of the cylinder, and recirculating the water continuously. The water may be drawn from an open pan or water reservoir 150 by a flexible hose 120. Water expelled from the cylinder liner end may be collected in the water reservoir 150 as the piston 130 reciprocates within the cylinder liner 110, thus pushing the cooling water from the power end of the cylinder liner. This expelled water is thrown forcefully by the piston 130 horizontally against the connecting rod seal 141 in the gear housing 142.

Because of the extreme force associated with the piston 130 and connecting rod 135, this water may be expelled from the cylinder liner 110 with excessive force, resulting in an overshoot of the water reservoir 150 by the expelled water. After a short period of operation, the seal 141 may become slightly worn, so that it falls downwardly slightly to open up a small gap on its upper side along the connecting rod 135. When directed against the seal 141, this forceful overshoot of water may enter the interior of the gear housing 142. The presence of this water within the gear housing frequently contaminates the oil sump 145, necessitating a costly cleaning operation for the oil sump 145 and replacement of the contaminated oil with fresh lubricating oil. This cleaning and oil replacement operation is rendered more costly by the downtime and idling of an expensive oil rig.

Another problem source is the use of flexible hoses to provide the cooling water 125. When the nozzle 133 is mounted on the connecting rod 135, as shown, then the continuous reciprocating movement may cause premature wear of the connecting hose 120 as it moves with the connecting rod 135. Other mounting options may allow the connecting hose 120 to rub against the connecting rod 135 to frictionally fray the hose and also cause premature wear. When the connecting hose 120 breaks, the mud pump 100 must be taken out of service for repair. As previously stated, this downtime represents a significant cost to the rig operator.

Still another source of problems involves the nozzle 133. Frequently the water reservoir 150 is covered by either a quilted stamped metal cover or a cover fabricated from expended metal, in order to allow oil rig personnel to stand thereon to perform various operations. Small debris from the worker's boots, as well as from other sources, may find its way into the water reservoir 150. When the water is recirculated, such small debris may be sucked up into the hose connected to the nozzle 133, where it lodges in the orifice of the nozzle 133 and blocks the flow of cooling water. When this happens, the flow of cooling water is stopped and the cylinder liner 110 and piston 130 may become overheated, resulting in failure of the cylinder liner 110. The mud pump 100 must then be repaired at considerable cost in material, labor, and downtime.

Attempts have been made to solve this deflection problem, but with little success. A rod deflector 155 may be used, where the rod deflector 155 is attached about the connecting rod 135, to intercept the forcible ejection of water horizontally from the open cylinder liner end, but such devices have proven to be either too flimsy to withstand the force or too dangerous to the worker.

As can be seen, there is a need for an assembly, apparatus, and method for preventing the water expelled from the mud pump cylinders from contaminating the oil sump and causing expensive downtime for cleanup.

### SUMMARY OF THE INVENTION

A deflector is provided for deflecting cooling water expelled by a piston from a horizontally disposed cylinder liner having a cylinder liner end, the cylinder liner containing the piston urged by a connecting rod for reciprocal movement therethrough, the expelled water being deflected by the deflector into a water pan for recirculation, where the deflector comprises a shield rigidly connected across the cylinder liner end, with the shield adapted to avoid contact with the reciprocating rod; and at least one tube having a first tube end and a second tube end, the second tube end rigidly mounted and directed through an opening in the shield, the first tube end receiving water from a water source to provide a water stream at the second tube end, the second tube end disposed to direct the water stream into the cylinder liner inwardly against the piston for cooling purposes, such that the second tube end does not contact the piston or the connecting rod.

A deflection assembly is also provided for cooling a horizontally disposed piston reciprocated by a connecting rod by use of a water stream, deflection assembly comprising a cylinder liner having and interior and a cylinder liner end, the piston traveling in a reciprocating motion along and within the interior; a shield disposed across an upper portion of the cylinder liner end, the shield adapted to avoid contact with the reciprocating rod; and at least one tube having a first tube end and a second tube end, the second tube end extending through the shield, the first tube end receiving a water stream, the second tube end arranged to direct the water stream horizontally across an upper portion of the interior against the piston.

A method for cooling a horizontal cylinder of a mud pump is also provided by the invention, where the method comprises the following steps without regards to order: arranging a vertical shield across a cylinder liner end of a cylinder liner that is attached to and extends the horizontal cylinder of the mud pump, the cylinder liner having a cylinder liner end and an interior, where the piston reciprocates through a portion of the cylinder liner interior; providing from a tube a water stream through an opening in the shield, the water stream received from a water source; directing the water stream horizontally along an upper portion of an interior of the cylinder liner and against the piston; and deflecting in a generally downward direction water which is forcibly expelled from the cylinder liner end against the shield by reciprocating action of the piston, wherein the deflected water is prevented from traveling horizontally away from the cylinder liner end and entering a gear box from which the connecting rod extends.

These and other features, aspects, and advantages of the present invention will become better understood with reference to the following drawings, description, and claims.

### BRIEF DESCRIPTION OF THE DRAWINGS

FIG. 1 shows a diagram of a typical mud pump having a reservoir and an oil sump, according to the prior art;

FIG. 2 shows a side perspective view of a water deflector, according to an embodiment of the invention;

FIG. 3 shows a perspective view of an opposing side of the water deflector shown in FIG. 2, according to an embodiment of the invention; and

FIG. 4 shows a flow diagram of a method of preventing cooling water forcibly ejected from the cylinder liner from contaminating the open oil reservoir located in the power end of the mud pump, according to an embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the current invention includes devices, assemblies, and methods for deflecting water emanating from an open horizontal cylinder during operation of a mud pump to prevent the cooling water from contaminating an oil sump used to lubricate the crankshaft of the pump. The invention enables continuous mud pump operation without incurring costly shutdowns for purposes of performing an oil change for the oil sump caused by overshoot water contaminating the oil sump. The invention may be attached to an end of a cylinder liner with sufficient frictional force so as to resist detachment therefrom by the force of cooling water expelled from the cylinder during a piston retraction stroke. The invention may be constructed of a fairly robust iron composition so as to resist fatigue during continuous operation of the mud pump.

This invention may find application in any piston pump that requires cooling by a water stream. In the oil and gas industry, this application is suitable for large mud pumps.

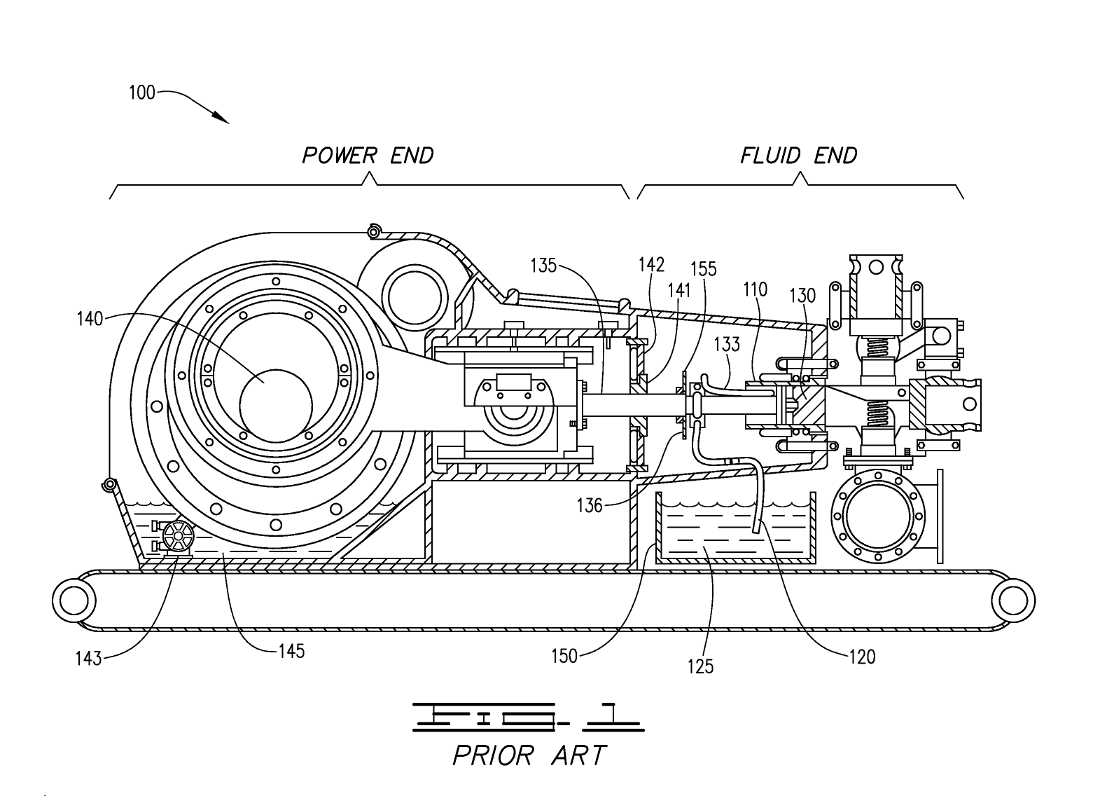

Referring now to FIG. 1 of the prior art, a typical setup is shown for a single cylinder horizontally disposed mud pump 100. The mud pump 100 may be configured with multiple cylinders, but only one is shown here for simplicity of discussion. A cylinder in a horizontal orientation may have a cylinder liner 110 attached to the end of the cylinder. A connecting hose 120 may provide cooling water 125 to prevent heat generated by the piston 130 from excessively damaging the cylinder liner 110. The cooling water 125 may be sprayed through a nozzle 133 mounted on the connecting rod 135, by means of a clamp about the rim of the cylinder liner 110, or at any other convenient attachment point. The piston 130 may be reciprocatingly attached to one end of a connecting rod 135, the other end of which is attached to a journal of a jack shaft 140, which continuously moves the piston 130 through the cylinder liner 110. An open oil sump 145 may be provided beneath the jack shaft 140 to maintain lubrication of the journals of the jack shaft 140.

During operation of the mud pump 100, cooling water 125 may be continuously sprayed into the cylinder liner 110 to remove heat generated by friction between the cylinder liner 110 and the piston 130. This cooling water 125 may be forcibly ejected from the cylinder liner 110 during retraction of the piston 130. Most of this cooling water 125 may flow as by gravity into a water reservoir 150 to be recirculated through the connecting hose 120. However, some cooling water 125 along the upper portion of the cylinder liner 110 may be ejected with sufficient force that it overshoots the reservoir 150 against the connecting rod seal 141 about the connecting rod 135 with sufficient force to enter the gear housing 142 and contaminate the oil sump 145. This accumulation of water in the oil sump 145 will necessitate shutting down of the mud pump, cleaning the contaminated oil/water combination from the oil sump 145, and replacing it with fresh oil. Furthermore, debris in the reservoir 150 may be sucked up into the lines going to the nozzle 133 and may lodge in the orifice of the nozzle 133, thus causing overheating and shutdown of the pump. Such shutdowns are costly and result in added expense in personnel and equipment.

Cooling water pumped from the reservoir 150 to be spayed into the cylindrical liner 110 may be splashed onto the connecting rod 135 that reciprocates the piston 130 of the mud pump 100 or against the gear housing 142 through which the connecting rod 135 emerges. The piston 130 and connecting rod 135 run in a horizontal fashion, and water may be sprayed horizontally along the upper portion of the cylinder liner 110 against the backside of the piston 130 for cooling and lubrication purposes. This results in excessive splashing, particularly during the backstroke, thus allowing water to accumulate on top of the connecting rod 135. The seal 141 associated with the connecting rod 135 is designed to keep out contaminates and protect the power end of the pump. However, the seal 141 often fails to keep expelled water from contaminating the oil. The weight of the connecting rod 141 causes rapid wear of the seal 141 after thousands of strokes per well. Furthermore, the horizontal orientation of the piston 130 tends to promote wear along the bottom of the seal 141. Both conditions allow miniscule openings at the top of the seal 141 resulting from the resulting drop of the connecting rod 135 by gravity. These openings permit water to enter the gear case 142 more easily and as such contaminate the gear oil.

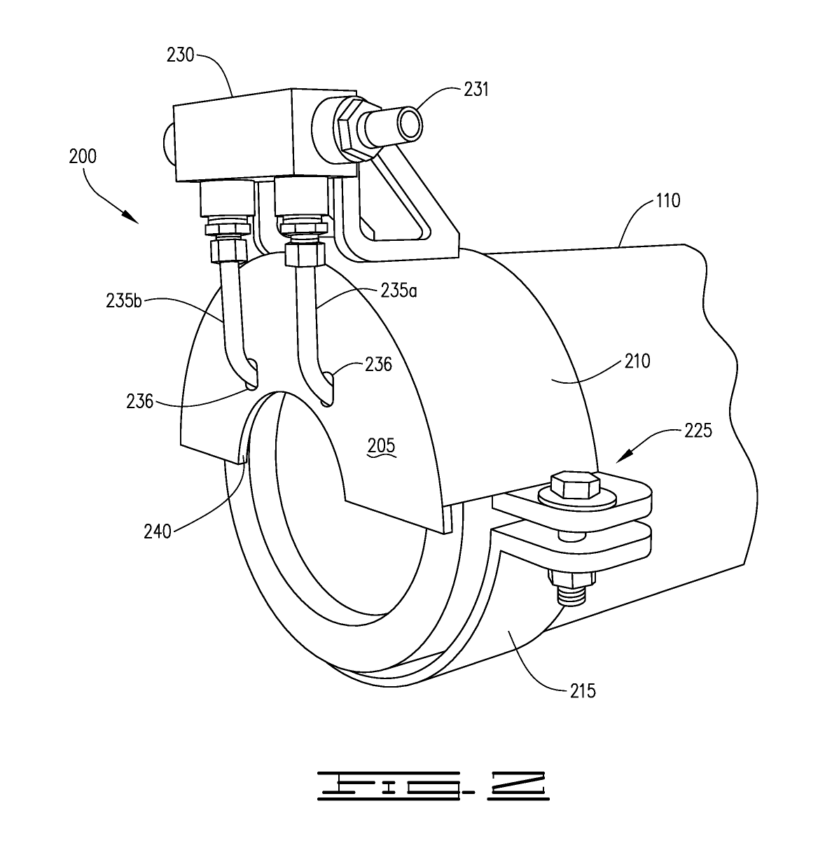

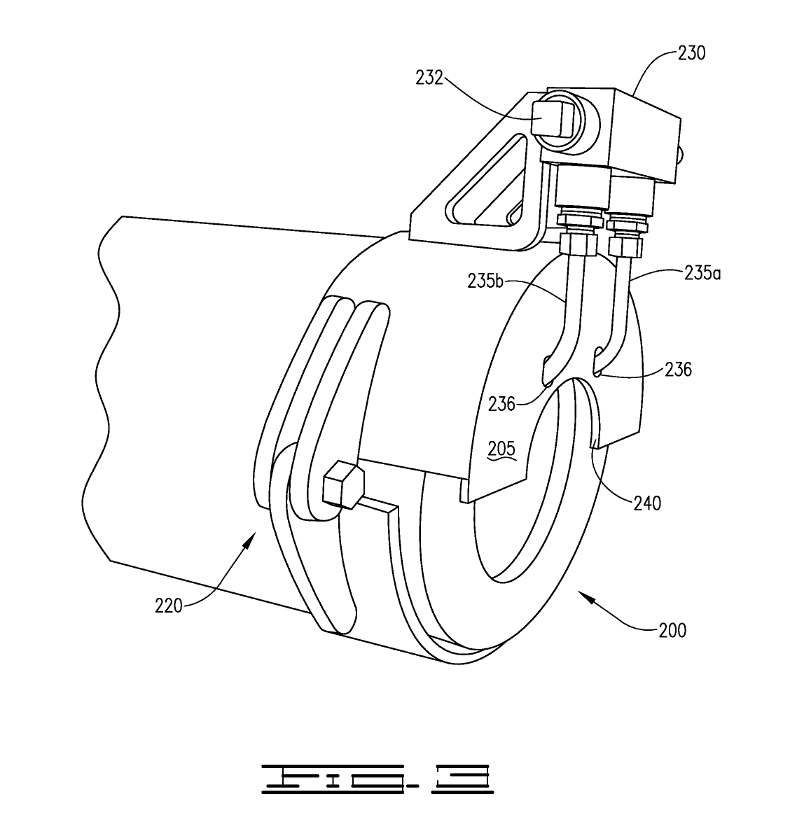

Referring to FIGS. 2 and 3, one embodiment 400 of the invention may be shown, which provides a deflector 200 for preventing water from contaminating the sump oil. The deflector may be constructed of steel, cast iron, or other like material so that it can withstand heavy use. It may be mounted on to the rim of the cylinder liner 110 to provide a shield 205 that covers an upper portion of the end of the cylinder liner 110. This shield 205 may keep the majority of water off of the connecting rod 135, and as such may vastly reduce the amount of water contaminating the gear end oil.

The deflector 200 may be constructed in two parts, an upper portion 210 and a lower portion 215. The upper and lower portions 210, 215 may have a curvature that conforms to the curvature of the cylinder liner 110 and may closely conform to the cylinder liner 110 about its circumference. The upper and lower portions 210, 215 may be arranged about the end of the cylinder liner 110 for frictional engagement, by attaching the ends of the upper and lower portions 210, 215 to one another by any convenient means. For example, in the embodiment shown in FIGS. 2 and 3, one pair of ends may be connected by a hinge 220 and the other pair of ends may be attached by any convenient connection means that is removable, such as a bolt 225. The bolt 225 may be tightened with sufficient force so as to frictionally maintain the deflector 200 on the end of the cylinder liner 110 in a manner to withstand the force of expelled cooling water from the cylinder. It should be noted that although a hinge 220 and bolt 225 connection means is shown, other methods of securing the deflector 200 to the cylinder liner end may be used without departing from the scope of the invention.

The deflector 200 may also have a water manifold 230 attached thereon for connection 231 to a water supply hose from a water pump connected to a water source. The connection 231 may be any standard connection used in the industry to secure the water supply hose, including so called quick disconnects as well as threaded arrangements. The water manifold 230 may have a connection 231 on either end, with a cleanout plug 232 attached to the opposing end. This arrangement may allow debris that accumulates in the water manifold 230 to be easily flushed from the water manifold 230 when the mud pump is shut down. Water may be provided from the water manifold 230 to one or more tubes 235a, 235b which may direct the water through the tubes as mounted on the shield 205 through openings 236 into the interior of the cylinder liner 110. These openings 236 may simply be oversized holes in the shield 205 as shown to permit the tubes 235a, 235b to enter the end of the cylinder liner. The holes may be oversized to permit easy removal of the tubes 235a, 235b for cleaning without removing the deflector 200 from its attachment to the end of the cylinder liner 110. The shield 205 may have a centrally-located cutout to allow the connecting rod to run through it with minimal clearance.

The embodiment thus described shows a deflector 200 that is removable and that can be retrofit to existing mud pumps 100 without any modification to the cylinder liner 110. However, the invention may be fabricated as a special deflector assembly where the shield 205, tubes 235a, 235b, and/or manifold 230 of the deflector 200 may be incorporated into a specially fabricated cylinder liner and provided as an integral unit. In such assemblies, the cylinder liner 110 may either be unmodified as previously described or modified to eliminate the removable collar arrangement and replace it with an attachment means that may involve modification of the cylinder liner 110. For example, the cylinder liner 110 may be fabricated with a flange (not shown) around the circumference of the cylinder liner end (or at least traversing an upper portion of the cylinder liner end), the shield 205 being attached to the flange (not shown) by a plurality of nut and bolt combinations inserted through horizontally oriented bolt holes in the shield 205 and flange. This embodiment would have the advantage of being removable to allow insertion and removal of the piston 130 from the cylinder liner end. In another embodiment, the shield 205 may be welded to the cylinder liner end to create the deflector assembly, but this would require complete removal of the deflector assembly for maintenance and/or removal of the piston 130. In both these embodiments, the cylinder liner 110 may be further modified to rigidly support a manifold 230. The shield 205 may be modified to insert permanent fittings in the openings 236 of the shield 205 so that the tubes may be modified to be removably attached to the manifold 230 and the fitting, and then a second portion of the tube may be fabricated to be removably attached to the interior side of the fitting without encountering the piston 130 on its stoke. Other similar embodiments may be suggested by this disclosure without departing from the scope of the invention.

A invention also includes a method of preventing contamination of the open oil sump located in the power end of the mud pump 100 from being contaminated by cooling water that is forcibly ejected from the end of the cylinder liner 110 by the reciprocating action of the piston 130. The method comprises the following steps, as listed below. They may be practiced in any practical order without departing from the scope of the invention.

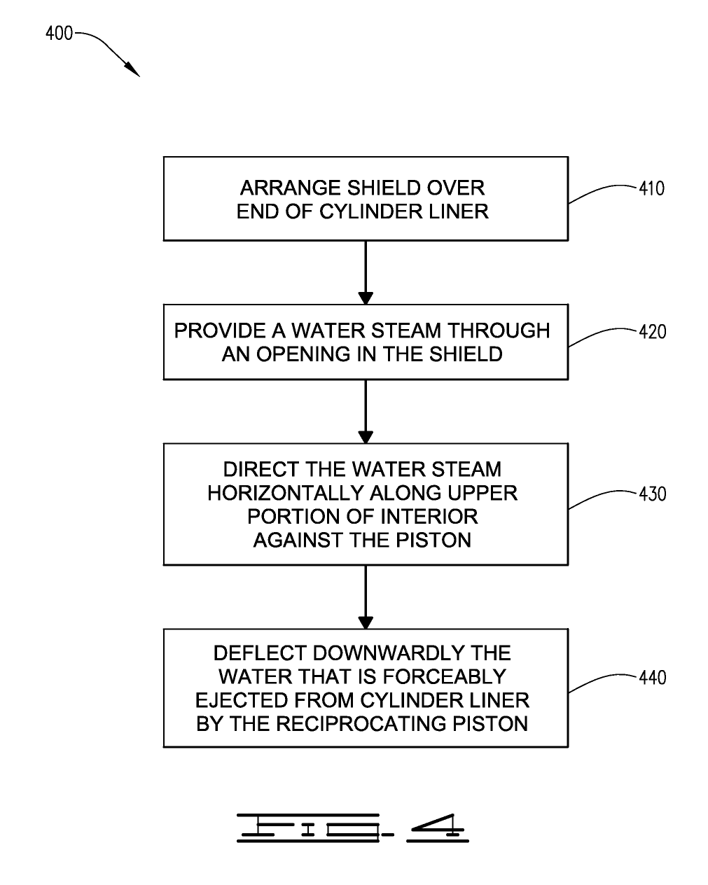

Referring now to the flowchart 400 shown in FIG. 4, a generally vertical shield may be arranged across the cylinder liner end of a cylinder liner that is attached to and extends the horizontal cylinder of the mud pump, according to the block designated as 410. The piston may reciprocate through the interior of the cylinder liner without extending beyond the cylinder liner end. This shield may be vertical or inclined at an angle, and the shield may also be flush with the cylinder liner end or spaced a distance from the cylinder liner end. The values for the distance from the cylinder liner end and the inclined angle of the shield, if any, may be determined by experiment according to the force of the expelled water and the length of the connecting rod, and these values are not pertinent to the inventive method. The significant aspect of this step is to provide a means of keeping all or most of the expelled water from entering the gear box from which the connecting rod emanates. The shield may cover an upper portion of the cylinder liner end and have a portion removed to allow the piston's connecting rod to travel back and forth without affecting the placement of the shield; sufficient space may be allowed through a lower portion of the cylinder liner end to permit expelled water from leave the interior of the cylinder liner without affecting the arrangement or configuration of the shield.

A water stream from a water source may be provided through a tube inserted through an opening in the shield, according to the block designated as 420. This tube may not be provided with a nozzle necessarily having a small orifice, since debris may plug the orifice and prevent the water stream from flowing. The tube may have a large opening to prevent such plugging. Furthermore, two or more tubes may be provided for redundancy so that if one tube fails, the remaining tubes may provide sufficient cooling water to the interior of the cylinder liner. Also, a manifold from which all the tubes emanate may be provided so that the water stream has a path through the remaining tubes to the cylinder liner interior.

The water stream may be directed horizontally along an upper portion of an interior of the cylinder liner and against the piston, according to the block designated as 430. This horizontally directed water stream may provide additional cooling action to the upper portion of the cylinder liner before it impacts the face of the piston.

The water which is forcibly expelled from the cylinder liner end against the shield by reciprocating action of the piston may be deflected in a generally downward direction by the shield, according to the block designated as 440. This action may prevent the expelled water from traveling horizontally away from the cylinder liner end, along the connecting rod, and entering the gear box from which the connecting rod extends. Gaskets about the connecting rod wear with time and provide a gap through which such expelled water may enter the gear box. The deflecting action of the shield may prevent a majority, if not all, of the expelled water from the gasket and reduce the probability of water entering the gear box.

There may be a number of benefits realized by the invention. The arrangement of fixedly mounting the water manifold 230 onto the splash shield has the added benefit of allowing the water hose to also be fixedly mounted so that it does not sag or otherwise contact any moving parts within the mud pump 100. In this way, it can be prevented from premature wear resulting from contact with moving parts.

Experimental use of the invention suggests that such use may extend the lifetime of the cylinder liner and the mean time between replacement maintenance actions. This is believed to be due to three phenomena. First, the invention permits more cooling water to be retained within the cylinder so that its cooling effect is enhanced. Second, the horizontal spraying action across the upper portion of the cylinder may cool this portion more than heretofore and not allow that portion to become heated disproportionately from other areas along the cylinder wall. Third, the elimination of the nozzle allows a greater volume of water to be delivered through the tubes since the flow is not constricted by a small orifice that may be easily clogged by small debris.

Another benefit of the invention may arise from the use of redundant tubes providing cooling water within the cylinder. This redundancy may (1) allow more water to enter the cylinder for cooling, and (2) provide a failsafe mechanism in case debris enters one of the tubes and blocks it. A single tube may be used, but it is preferable to use two or more in order to provide the benefits of redundancy. Additional tubes may be attached to the manifold for cooling purposes without departing from the scope of the invention.

From the foregoing, it will be understood by persons skilled in the art that a water deflection apparatus has been provided for a horizontally oriented cylinder of a mud pump. The invention is relatively simple and easy to manufacture, yet affords a variety of uses for other similarly disposed pumping mechanisms. While the description contains many specifics, these should not be construed as limitations on the scope of the invention, but rather as an exemplification of the preferred embodiments thereof. The foregoing is considered as illustrative only of the principles of the invention. Further, because numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention, as set forth in the following claims.

We claim:

1. A deflector for deflecting cooling water expelled by a piston from a horizontally disposed cylinder liner having a cylinder liner end, the cylinder liner containing the piston urged by a connecting rod for reciprocal movement therethrough, the expelled water being deflected by the deflector into a water pan for recirculation, the deflector comprising:
a shield rigidly connected across an upper portion of the cylinder liner end, the shield adapted to avoid contact with the reciprocating rod; and
at least one tube having a first tube end and a second tube end, the second tube end rigidly mounted and directed through an opening in the shield, the first tube end receiving water from a water source to provide a water stream at the second tube end, the second tube end disposed to direct the water stream into the cylinder liner inwardly against the piston for cooling purposes, wherein the second tube end does not contact the piston and the connecting rod.

2. The deflector described in claim 1, wherein the first tube end is connected to a manifold that receives water from the water source and provides the received water to the second tube end.

3. The deflector described in claim 1, wherein the shield is connected to a removable collar about a circumference of the cylinder liner end for removable engagement with the cylinder liner end.

4. The deflector described in claim 3, wherein the manifold is fixedly supported by the collar.

5. The deflector described in claim 3, wherein the collar comprises
a gap along a circumference of the collar, the gap characterized by a distance between opposing gap edges; and
a connecting mechanism attached to the opposing gap edges, the connecting mechanism disposed to reduce the distance when the collar is arranged about the cylinder liner end, wherein the collar frictionally engages the cylinder liner end as the distance is reduced.

6. The deflector described in claim 3, wherein the collar comprises
a first collar portion with a first end and a second end;
a second collar portion with a third end and a fourth end;
a first connection mechanism connecting the first end and the third end; and
a second connection mechanism removeably connecting the second and fourth ends.

7. The deflector described in claim 6, wherein the first collar portion and the second collar portion each traverse less than half the circumference.

8. The deflector described in claim 6, wherein the first connection mechanism is a hinge.

9. A deflection assembly for cooling a horizontally disposed piston reciprocated by a connecting rod by use of a water stream, deflection assembly comprising:
a cylinder liner having and interior and a cylinder liner end, the piston traveling in a reciprocating motion along and within the interior;
a shield disposed across an upper portion of the cylinder liner end, the shield adapted to avoid contact with the reciprocating rod; and
at least one tube having a first tube end and a second tube end, the second tube end extending through the shield, the first tube end receiving a water stream, the second tube end arranged to direct the water stream horizontally across an upper portion of the interior against the piston.

10. The deflection assembly described in claim 9, wherein the first tube end is connected to a manifold that receives the water stream from a water source and provides the received water stream to the second tube end.

11. The deflection assembly described in claim 9, wherein the shield is connected to a removable collar about a circumference of the cylinder liner end for removable engagement with the cylinder liner end.

12. The deflection assembly described in claim 11, wherein the manifold is fixedly supported by the collar.

13. The deflection assembly described in claim 11, wherein the collar comprises
a gap along a circumference of the collar, the gap characterized by a distance between opposing gap edges; and
a connecting mechanism attached to the opposing gap edges, the connecting mechanism disposed to reduce the distance when the collar is arranged about the cylinder liner end, wherein the collar frictionally engages the cylinder liner end as the distance is reduced.

14. The deflection assembly described in claim 11, wherein the collar comprises
a first collar portion with a first end and a second end;
a second collar portion with a third end and a fourth end;
a first connection mechanism connecting the first end and the third end; and
a second connection mechanism removeably connecting the second and fourth ends.

15. The deflection assembly described in claim 14, wherein the first collar portion and the second collar portion each traverse less than half the circumference.

16. The deflection assembly described in claim 14, wherein the first connection mechanism is a hinge.

17. The deflection assembly described in claim 9, wherein the cylinder liner is attached to and extends a cylinder of a mud pump.

18. A method for cooling a horizontal cylinder of a mud pump, the method comprising the following steps:
arranging a vertical shield across a cylinder liner end of a cylinder liner that is attached to and extends the horizontal cylinder of the mud pump, the cylinder liner having a cylinder liner end and an interior, wherein the piston reciprocates through a portion of the cylinder liner interior;
providing from a tube a water stream through an opening in the shield, the water stream received from a water source;
directing the water stream horizontally along an upper portion of an interior of the cylinder liner and against the piston; and
deflecting in a generally downward direction water which is forcibly expelled from the cylinder liner end against the shield by reciprocating action of the piston, wherein the deflected water is prevented from traveling horizontally away from the cylinder liner end and entering a gear box from which the connecting rod extends.

19. The method described in claim 18, further comprising the following steps:
collecting the water expelled from and falling from the cylinder liner end in a water reservoir; and
providing the water stream from water collected in the water reservoir, wherein water is recirculated for cooling purposes.

20. The method described in claim 18, further comprising the following steps:
attaching at least two tubes to a manifold receiving the water stream, wherein failure of a selected tube to deliver the water stream will not prevent the piston from being cooled.
